(19) United States
(12) Patent Application Publication
(10) Pub. No.: US 2014/0366632 A1
(43) Pub. Date: Dec. 18, 2014

(54) sensor device for the contactless acquisition of a rotation characteristic of a rotatable object

(71) Applicants: Klaus Lerchenmueller, Rettenberg (DE); Mare Rosenland, Hohenhaslach (DE)

(72) Inventors: Klaus Lerchenmueller, Rettenberg (DE); Mare Rosenland, Hohenhaslach (DE)

(21) Appl. No.: 14/370,427

(22) PCT Filed: Nov. 22, 2012
(86) PCT No.: PCT/EP2012/073312

§ 371 Date: Jul. 2, 2014

(30) Foreign Application Priority Data
Jan. 4, 2012 (DE) 10 2012 200 091.7

(51) Int. Cl. G01P 3/49; G01K 7/16; F04D 27/00

(52) U.S. Cl. CPC G01P 3/49; F04D 27/001; G01K 7/16
USPC 73/509

(57) ABSTRACT

A sensor device is described for the contactless acquisition of at least one rotation characteristic of a rotatable object, in particular for acquiring a rotational speed of a compressor wheel of a turbocharger, and includes at least one sensor element. The sensor device also includes at least one magnetic-field generator for generating a magnetic field at the location of the rotatable object, and at least one magnetic-field sensor for detecting a magnetic field generated by eddy currents of the rotatable object. Moreover, the sensor device includes at least one temperature sensor. The magnetic-field generator and the magnetic-field sensor are jointly and at least partially disposed in a sensor section of the sensor housing. The temperature sensor is at least partially situated in the sensor section.

### FIELD OF THE INVENTION

The present invention relates to a sensor device for the contactless acquisition of a rotation characteristic of a rotatable object.

### BACKGROUND INFORMATION

Numerous sensors that acquire at least one rotation characteristic of rotatable, especially rotating, objects are believed to be understood from the related art. In principle, rotation characteristics are characteristics that at least partially describe the rotation of the rotatable object. For example, these may be angular velocities, rotational speeds, angular accelerations, angles of rotation, angular positions or other characteristics that can characterize a continuous or discontinuous, even or uneven rotation of the rotatable object.

Examples of such sensors are discussed in Konrad Reif (publisher): Sensoren im Kraftfahrzeug [Sensors in the Motor Vehicle], 1st edition 2010, pages 63-73. A particular focus of the present invention, although not restricted thereto in principle, is a rotational speed acquisition, especially the rotational speed acquisition of charge devices, in particular in exhaust-gas turbochargers. This rotational speed acquisition may specifically be set up to acquire a rotational speed of a rotor of the exhaust-gas turbocharger. This rotor is typically provided with a plurality of compressor blades and may therefore also be referred to as a compressor wheel.

A method for measuring the motion of a part in an interior of a housing is discussed in German publication DE 196 23 236 A1.

In this case a permanent magnetic field is generated, which acts essentially perpendicularly to a movement direction of the part, and induction signals are produced and measured when the part is passing by. The magnetic field, for example, can be generated by a permanent magnet, and the induction signals, which may be the result of eddy currents in moving compressor blades, can be detected with the aid of a coil, which is situated outside the compressor housing.

The publication U.S. 2007/0139044 A1 discusses a rotational speed sensor, in which the electrical components are encapsulated in a temperature-stable material.

A sensor device in which a first and a second cavity are developed in a housing section is discussed in publication US 2007/0119249 A1. It is possible, for example, to place a speed sensor for measuring a vehicle speed inside the first cavity, and a temperature sensor for measuring an ambient temperature of the vehicle can be placed inside the second cavity.

Despite the numerous advantages of the previously known sensor devices for acquiring a rotation characteristic of a rotatable object, there is still room for improvement. For example, the sensor device for acquiring a rotation characteristic of a rotating object, especially a compressor wheel of an exhaust-gas turbocharger, is typically mounted on the compressor housing, because the thermal ambient conditions there at lower temperatures are easier to manage than on the exhaust gas side. Additional physical quantities, such as the pressure or temperature, are acquired separately, with the aid of the rotational speed sensors in the environment of the exhaust-gas turbocharger. As a result, this necessitates additional components and sensors for monitoring and controlling the internal combustion engine.

### SUMMARY OF THE INVENTION

Therefore, a sensor device for acquiring a rotation characteristic of a rotatable object is provided, which at least for the most part avoids the disadvantages of known sensor devices and provides a simple configuration; here, not only the rotation characteristic but also one or more other physical parameter(s) or quantity(ies) is/are able to be acquired in qualitative and/or quantitative terms, using the sensor device.

The sensor device for the contactless acquisition of at least one rotation characteristic of a rotatable object, especially for, the acquisition of a rotational speed of a compressor wheel of a turbocharger, includes a sensor housing; the sensor device furthermore includes at least one magnetic-field generator for generating a magnetic field at the location of the rotatable object, and at least one magnetic-field sensor for detecting a magnetic field generated by eddy currents of the rotatable object. In addition, the sensor device includes at least one temperature sensor. The magnetic-field generator and the magnetic-field sensor are jointly and at least partially disposed in a sensor section of the sensor housing. At least apart of the temperature sensor is situated in the sensor section.

The sensor housing is able to be mounted on a device that includes the rotatable object. The magnetic-field generator may be aligned along an axis, and a longitudinal axis of the sensor section may essentially extend in parallel with the axis of the magnetic-field generator. The sensor section is developed in such a way that in a state of the sensor housing in which it is mounted on the device that includes the rotatable object, one part of the device is located between the sensor section and the rotatable object in a direction that runs essentially parallel to the longitudinal axis of the sensor section. The sensor device may include an evaluation circuit, and a signal from the temperature sensor is able to be transmitted, separately from or jointly with a signal of the magnetic-field sensor, from an output of the evaluation circuit to a control unit, for example. The signal of the temperature sensor is transmittable together with the signal of the magnetic-field sensor from an output of the evaluation circuit and may be modulated onto the signal of the magnetic-field sensor using a modulation method. With the aid of a pulse width modulation or a multiplexing method, the signal from the temperature sensor is able to be modulated onto the signal from the magnetic-field sensor. The signal of the temperature sensor is transmittable from the output of the evaluation circuit, separately from the signal from the magnetic-field sensor, and the evaluation circuit may have a port that is set up for transmitting the signal of the temperature sensor.

The signal of the temperature sensor is transmittable from the output of the evaluation circuit separately from the signal from the magnetic-field sensor, and the evaluation circuit may include an intelligent interface set up for transmitting the signal of the magnetic-field sensor. The magnetic-field sensor can be an inductive magnetic-field sensor. The temperature sensor may be developed to acquire a temperature of a wall of the device that includes the rotatable object. The sensor section may be embodied as a non-magnetic sleeve and developed to be introduced into a recess in a wall of the device; in the introduced state, a gap may be situated between the sensor section and the part of the device in the direction of the longitudinal axis of the sensor section. The dimension of the part of the device in the direction of the longitudinal axis may range from 0.1 mm to 2 mm, which may be from 0.2 mm to 1.8 mm, and even more which may be, from 0.5 mm to 1 mm. The sensor section may be introduced into a recess in a wall of the device and in the installed state, a coaxial gap may at least regionally be situated between the wall of the device and the sensor section. The sensor device could be a rotational speed sensor, and the rotatable object a compressor wheel of a charger, especially of an exhaust-gas turbocharger.

The object may be rotatable about a pivot axle and in a state of the sensor housing in which it is mounted on the device, the longitudinal axis of the sensor section may be disposed at an angle of 25° to 65° and, especially which may be, 30° to 60°, and even more which may be, 45° in relation to the pivot axle. A compressor wheel, for example, may be rotatable about a pivot axle and in a state of the sensor housing in which it is mounted on the device, the longitudinal axis of the sensor section may be disposed at an angle of 25° to 65° and, especially which may be, 30° to 60°, and even more which may be, 45° in relation to the pivot axle. The sensor housing may include segments and/or circular projections which touch the device in a state of the sensor housing in which it is mounted on the device that includes the rotatable object. The sensor device may include an amplifier, which is set up to amplify a signal supplied by the magnetic-field sensor.

The magnetic-field sensor in particular can include at least one coil, which offers the advantage that large sensor surfaces are able to be realized with the aid of coils. At the same time, the use of coils makes it possible to avoid temperature sensitivities, which occur in semiconductor magnetic-field sensors or magnetoresistive sensors, for example. The coil, for instance, may be a flat coil and may have a coil cross-section having a winding area that may be planar or also curved, which may exceed a coil height of the coil, e.g., along an axis of the coil.

In particular, the magnetic-field generator may have a permanent magnet, such as precisely one, two, three or more permanent magnet(s). It may in particular be at least partially enclosed by the magnetic-field sensor. This can be accomplished in that the coil encloses the permanent magnet completely or partially, for example. The permanent magnet may also have a rectangular and/or oval form, for instance, featuring a longer side or longer semi-axis in a plane that includes the axis of the rotatable object.

Within the scope of the present invention, rotation characteristics are basically characteristics that at least partly describe the rotation of the rotatable object. For instance, these may be angular velocities, rotational speeds, angular accelerations, angles of rotation, angular positions or other characteristics that could characterize a continuous or discontinuous, even or uneven rotation of the rotatable object.

A temperature sensor within the framework of the present invention describes any type of known temperature sensor, but especially so-called NTCs, i.e., temperature-dependent electrical resistors having a negative temperature coefficient, whose electrical resistance varies with the temperature, especially drops with rising temperature. However, PTCs, i.e., electrical resistors having a positive temperature coefficient, whose resistance increases with rising temperature, are conceivable as well.

Within the framework of the present invention, the expression “essentially in parallel” with reference to a direction describes a deviation of maximally 15°, especially maximally 10°, especially maximally 5° and, especially which may be, 0°, from the direction to which it is referred.

When angles between two directions or axes are indicated within the framework of the present invention, this refers to an angle between the directions or axes, the axes theoretically intersecting, so that with the exception of a rectangular arrangement with respect to each other, they define between them two angle pairs of different size, it always being the case in the present invention that an angle of the smaller angle pair is referred to.

A housing interior within the scope of the present invention specifically describes the particular space inside a housing of a sensor device for the contactless acquisition of a rotation characteristic of a rotatable object, in which the electronics are situated, such as the evaluation circuit and its electrical connections, so that this space may also be referred to as the electronics space.

A pulse-width modulation within the scope of the present invention describes a method in which a technical quantity, e.g., a voltage signal or an electric current, fluctuates between two values. At a constant frequency, the duty factor of the signal, that is to say, the width of a pulse, is modulated. The modulation describes a procedure in which a useful signal to be transmitted, such as a temperature signal, modifies, i.e., modulates, a so-called carrier, such as a rotational speed signal. On the receiver side, the information or message included in the useful signal is recovered by a demodulator. The duty factor, which is also referred to as phase control factor, indicates the ratio of the pulse duration to the pulse period duration for a periodic sequence of pulses. The duty factor is indicated as a dimensionless ratio having a value of 0 to 1 or 0 to 100%.

Within the scope of the present invention, a multiplexing method describes a method for transmitting signals or messages, in which multiple signals are combined or bundled and simultaneously transmitted via a medium, e.g., a wire, a cable or a radio link. Multiplexing methods are frequently also combined in an effort to achieve an even higher utilization. The bundling takes place after the useful data have been modulated onto a carrier signal. Accordingly, they are demodulated in the receiver following the debundling, which is also known as demultiplexing.

The sensor device, for example, may be a rotational speed sensor, which, for instance, is made up of a passive sensor head or sensor section, an active signal amplifier/pulse shaper, a housing having a fastening bushing and a plug connector. For instance, the sensor head may include a magnetic circuit having an inductivity, e.g., a fine wire winding, on a coil shell. A holder may be situated within a sleeve of the sensor head and accommodate all individual parts of the sensor head together with the connection technology as well as a possibly provided temperature sensor element. The holder, for example, may be made completely or partially from plastic, using injection technology. The temperature sensor, which detects the temperature in the sensor head, is placed as closely as possible to the inner wall of the sleeve and may be an NTC resistor or a PTS resistor or also a semiconductor, for instance.

The temperature sensor, for instance, is a so-called NTC, i.e., an electric resistor having a negative temperature coefficient, in which the electrical resistance drops with rising temperature. The housing, including connector and lid, made from plastic, for instance, accommodates the sleeve, the holder, and the electronics and is used for the mechanical fixation of the components and for the protection from media. An outer contour of the housing, especially in the area of a bearing surface, is appropriately configured for a thermal decoupling. The signal amplifier in the housing, which, for example, . . . on a board having analog and/or digital components that may be integrated in an application-specific integrated circuit (ASIC), for instance, processes the rotational speed signal and, for example, forwards it to an engine control unit via the plug connection. A fastening bushing, which may be integrated into the housing and embodied there by a projection, is provided for the mechanical fixation on a compressor housing, for example.

Because of the sensor according to the present invention, a sensor housing having a sensor section may be used for a further signal transmission, without this enlarging the size of the sensor. An already existing rotational speed sensor, such as on a compressor housing of an exhaust-gas turbocharger, is thereby expanded by the temperature acquisition functionality. The sensor head is positioned as closely as possible to the passing compressor blades of the compressor wheel. The bore for accommodating the sensor head is developed in such a way that the interior region of the compressor channel is not penetrated and the scanning of the blades of the compressor wheel takes place through the remaining wall of the bottom hole bore in the compressor housing implemented from the outside. A wall thickness in the compressor housing between the sensor head and the blade of the compressor wheel that is as thin as possible has an advantageous effect on the signal-to-noise ratio of the rotational speed signal and is desirable because a higher signal amplitude is supplied.

The sensor head or sensor section of the rotational speed sensor mounted deeply inside the compressor housing is supplemented by an integrated temperature sensor and therefore detects the temperature of the compressor housing directly. Because of the pressure ratio between the compressor input, i.e., the end face of the compressor wheel, and the compressor output, i.e., the radially largest circumference of the compressor wheel, that is achieved depending on the operating speed, a very high temperature increase of the compressed aspirated air comes about. Because of the bottom hole in the compressor housing, which is sealed toward the inside, the thermal loading of the sensor head is reduced, inasmuch as the sensor head is not in direct contact with the hot compressed aspirated air in the compressor in the bottom hole sealed towards the inside. An average temperature that corresponds to the average temperature of the compressor housing comes about at the sensor head. The temperature sensor, mounted on the existing aforementioned holder, may be installed in the non-magnetic sleeve in the available space between sensor head and signal amplifier, and be electrically connected to the signal amplifier board.

The temperature-dependent resistance of the temperature sensor is able to be detected and processed further in the signal amplifier. The temperature value is transmitted to the control unit as well, which may be via the existing signal line. A pulse-width modulation of the rotational speed signal, for example, may be used for this purpose. A control unit is able to process this temperature as diagnostic value, for instance, for component protection and similar purposes. The temperature signal output on a rotational speed sensor according to the present invention may be implemented in the form of an additional pin. An additional pin is used to route the signal of the integrated temperature sensor to the control unit, the mass of the rotational speed sensor serving as common ground connection. As an alternative, there is the possibility of modulating the acquired temperature value onto the rotational speed signal. To do so, the rotational speed information is transmitted to the control unit, e.g., in the form of a square-wave signal, taking the period duration or the frequency analysis into account in an appropriate manner. In addition, it is possible to transmit the temperature information in a pulse-width modulated manner, for instance, by way of the electronics integrated into the rotational speed sensor.

A corresponding temperature/pulse width correlation may be realized via software functions. An intelligent interface may be used as a further alternative. Depending on the configuration and complexity of the electronics integrated into the rotational speed sensor, the information is therefore also transmittable via an intelligent interface, such as a single-edge-nibble transmission (SENT), a controller area network (CAN) or the like. A modulation of the acquired temperature value onto the rotational speed signal may be used, since the sensor supplies a real-time signal of the rotational speed in this case, so that run-time losses of the signal processing are avoided.

Except for the actual temperature sensor, no additional components are therefore required in the exhaust-gas turbocharger. Furthermore, no additional wiring in the vehicle or on the engine is necessary either. As a result, for example, an intake temperature downstream from the compressor is able to be ascertained indirectly. This temperature may be useful as an additional control variable for correcting the air density in the control unit.

Additional optional details and features of developments of the present invention result from the following description of exemplary embodiments, which are shown schematically in the figures.

### BRIEF DESCRIPTION OF THE DRAWINGS

FIG. 1 shows a first exemplary embodiment of a sensor device according to the present invention.

FIG. 2 shows a side view of a compressor housing.

FIG. 3 shows a side view of the rotor assembly of an exhaust-gas turbocharger.

FIG. 4 shows a perspective sectional view of the sensor device in a state in which it is secured on a compressor housing.

FIG. 5 shows an enlarged detail of the compressor housing and the compressor wheel.

### DETAILED DESCRIPTION

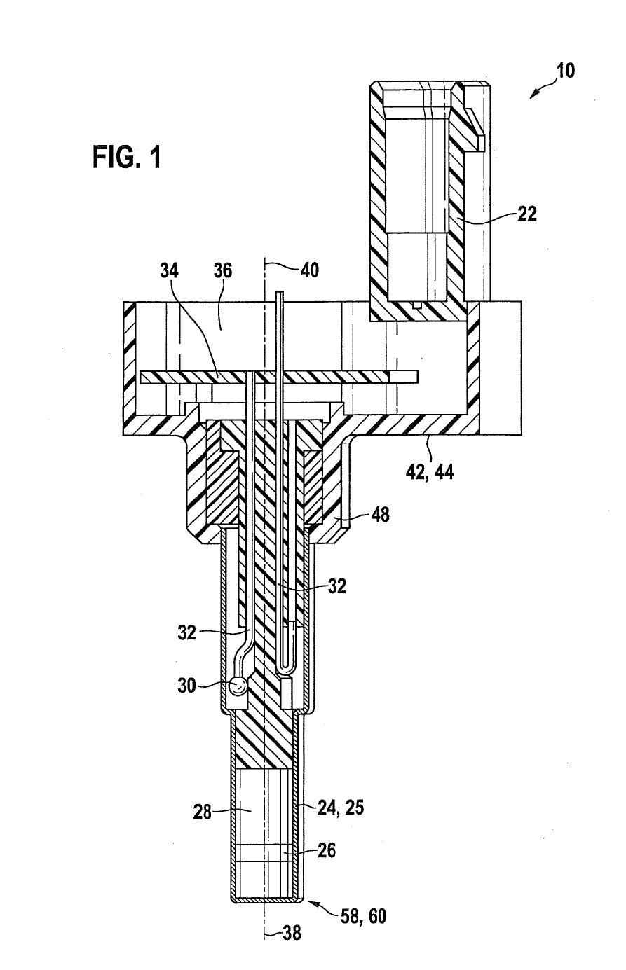

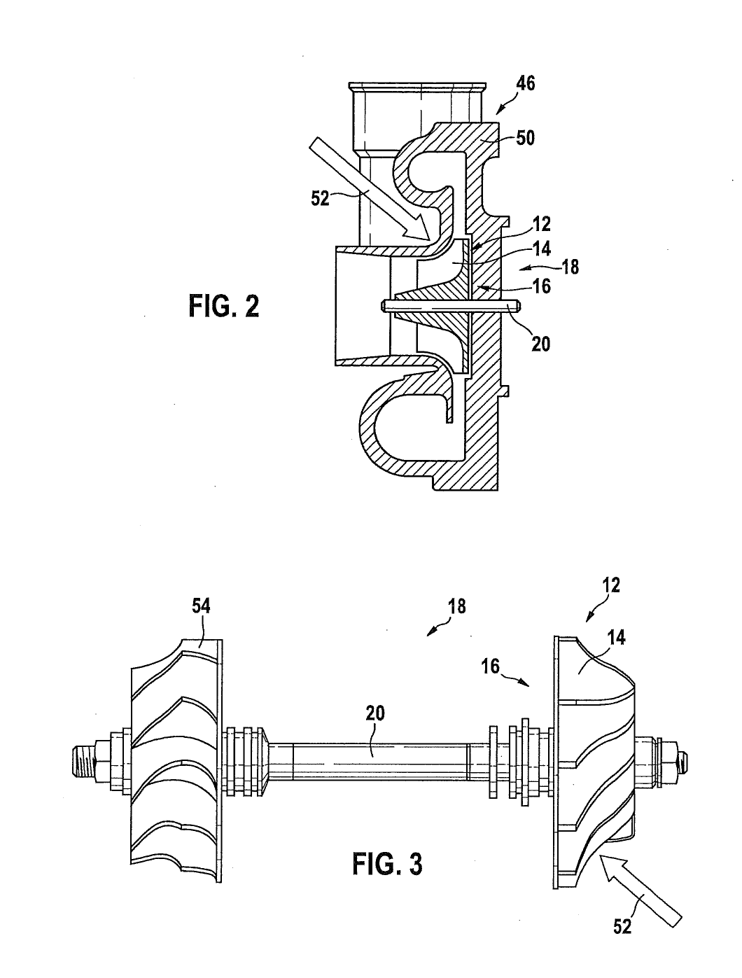

FIG. 1 shows a first exemplary embodiment of a sensor device 10 according to the present invention for the contactless acquisition of at least one rotation characteristic of a rotatable object 12 (see FIG. 2). As illustrated in FIGS. 2 and 3, in this exemplary embodiment rotatable object 12 is, for example, a compressor wheel 14 of a compressor 16 of the rotor assembly of an exhaust-gas turbocharger 18, which moves, especially rotates, about a pivot axis 20. Sensor device 10, for instance, is embodied as a rotational speed sensor, which detects a rotational frequency of compressor wheel 14. However, other uses and application fields are in principle possible as well.

Sensor device 10 includes a sensor housing 22, which may be produced at least partially from plastic and has a sensor section 24, which may be at least in part made from stainless steel. Sensor section 24 in particular is developed as a non-magnetic sleeve 25. Jointly disposed in sensor section 24 are at least one magnetic-field generator 26, which may be realized as a permanent magnet, and a magnetic-field sensor 28, which may jointly be mounted on a holder. Magnetic-field generator 26 is developed to generate a magnetic field, which may be a static magnetic field, at the location of rotatable object 12, which induces eddy currents in rotatable compressor wheel 14.

Magnetic-field sensor 28 may be developed as a coil. Magnetic-field sensor 28 detects a magnetic field generated by eddy currents of rotatable compressor wheel 14. Furthermore, a temperature sensor 30 may be disposed in sensor section 24. An electric connection, especially electrical supply lines 32, and/or connection elements, especially plug-in contacts, may also be situated in sensor section 24, just like temperature sensor 30, magnetic-field sensor 28 and magnetic-field generator 26. Supply lines 32 are connected to a circuit substrate 34 such as a circuit board, which is situated in a housing interior 36. Circuit substrate 34, for example, may support a control and/or evaluation circuit. In addition, an amplifier for amplifying the signals supplied by temperature sensor 30 and/or magnetic-field sensor 28 may be disposed on circuit substrate 34. An output of the control and/or evaluation circuit is connected to a control unit (not shown), such as an engine control unit.

Magnetic-field generator 26 may be aligned along an axis 38 that coincides with a longitudinal axis 40 of sensor section 24. For example, sensor section 24 may be developed in rotational symmetry about longitudinal axis 40. More specifically, sensor section 24 projects in an essentially perpendicular manner from an underside 42 of sensor housing 22. Underside 42 may be developed as bearing surface 44, for instance, by way of which sensor housing 22 at least partially rests on device 46 in a state in which sensor device 10 is mounted on a device 46 that accommodates rotatable object 12. Sensor section 24, in particular, may project from a projection 48 on underside 42 of sensor housing 22 which coaxially surrounds sensor section 24 regionally, i.e., not over the entire length of sensor section 24. Projection 48 may be developed as part of a fixation bushing or as a fixation bushing, which is integratable into sensor housing 22. Projection 48 is provided to center sensor housing 22 in device 46. It may coaxially surround sensor section 24 and thus support it in the radial direction. In addition, projection 41 may be developed as part of a fixation bushing or as a fixation bushing, which is integratable into sensor housing 22. For example, projection 41 may be a sleeve made of metal, which is extrusion-coated by plastic and provided with an outer thread developed for screwing sensor housing 22 into device 40.

As illustrated in FIG. 2, rotatable object 12 is situated or accommodated inside a device 46 which includes a compressor housing 50. Compressor housing 50 may at least partially be made from an aluminum cast alloy. In addition, an arrow 52 in FIG. 2 indicates a possible installation position of sensor device 10 on compressor housing 50.

As illustrated in FIG. 3, exhaust-gas turbocharger 18 generally includes a turbine wheel 54, which is drivable by flowing exhaust gas and connected to pivot axle 20; when turbine wheel 54 is turning, compressor wheel 14, which is likewise connected to pivot axis 20, is turning as well. The possible installation position of sensor device 10 on compressor housing 50 once again is indicated by arrow 52 in FIG. 3.

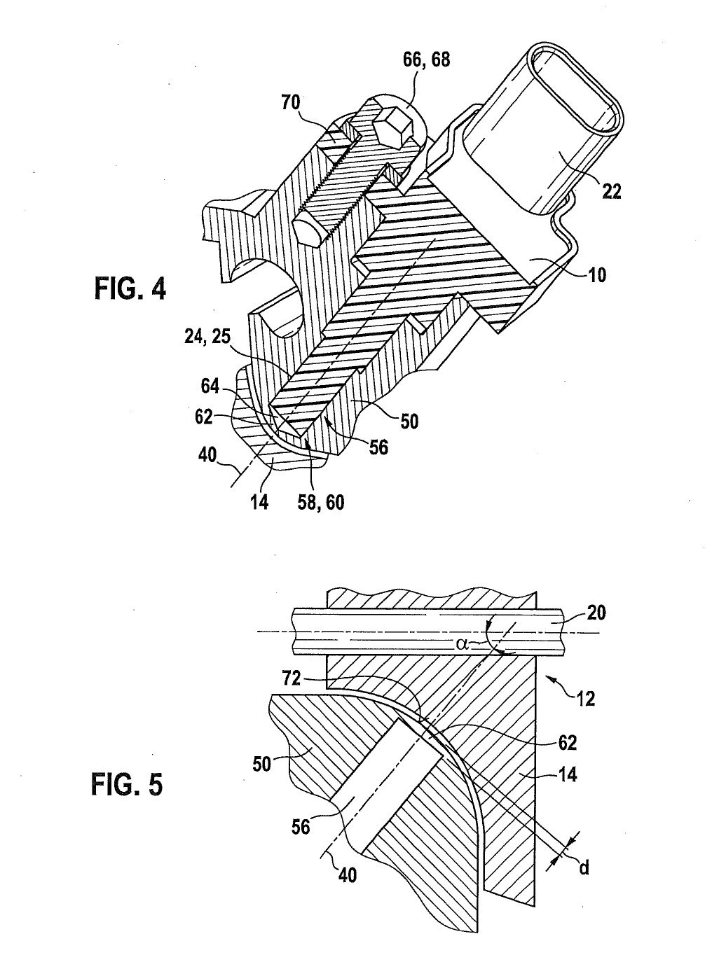

As illustrated in FIG. 4, compressor housing 50 has a receptacle 56 developed in the form of a blind hole. To mount sensor device 10 on compressor housing 50, sensor section 24 is inserted into receptacle 56; in so doing, a gap 64 is situated between an end 58, facing away from sensor housing 22, of sensor section 24, which constitutes a front end 60 of sensor section 24, and a part 62 of the wall of compressor housing 50 in the direction of longitudinal axis 40 of sensor section 24. Gap 64, for example, may have a dimension of 0.2 mm to 0.3 mm in the direction of longitudinal axis 40 of sensor section 24. The air situated in gap 64 between part 62 of the wall of compressor housing 50 and front end 60 of sensor section 24 may induce a thermal insulation since air has poorer thermal conductivity than the mentioned materials of compressor housing 50 and sensor section 24. Furthermore, a coaxial gap may be present between sensor section 24 and the wall sections of compressor housing 50 defining receptacle 56; this gap is likewise used for the thermal decoupling and may extend across the entire length or a partial length of sensor section 24 in the direction of longitudinal axis 40. For the final installation, sensor housing 22 is fixed in place on compressor housing 42 with the aid of a fastening arrangement 66. This fastening arrangement 66, for instance, may be developed in the form of a screw 68, which is inserted through a flange 70 on sensor housing 22. A sleeve made of metal or brass, for example, may be introduced into flange 70, such as by an extrusion coating with plastic, the sleeve being developed to prevent screw 68 from exerting direct pressure on the plastic of sensor housing 22 or flange 70 during the screw-fitting operation.

As illustrated in FIG. 5, compressor housing 50 is configured in such a way that a surface 72, facing compressor wheel 14, of sensor housing 22 has a curved profile, which may be a curved profile that is adapted to a curvature of compressor wheel 14. A curved profile means a non-planar profile. An adapted profile is a profile in which a distance between surface 72 and rotating compressor wheel 14 is essentially constant in at least one direction on surface 72 over at least a certain distance or area, for example in that this distance does not vary by more than 20%, which may be by no more than 10%, over a distance of at least 1 cm, which may be at least 2 cm. The distance between surface 72 and rotating compressor wheel 14, for instance, may be 0.05 mm to 0.3 mm and which may be 0.1 mm, for example.

FIG. 5 furthermore illustrates that part 62 of the wall of compressor housing 50 is disposed between receptacle 56 and compressor wheel 14. Part 62 may have a dimension d of 0.1 mm to 2 mm, which may be 0.2 mm to 1.8 mm, and even more which may be, 0.5 mm to 1 mm, e.g., 0.5 mm, in the direction of longitudinal axis 40 of sensor section 24; it is selected as small as possible in order to keep interference effects on the magnetic-field detected by magnetic-field sensor 28 to a minimum. In other words, it is desired that magnetic-field sensor 28 is able to detect a magnetic field generated by eddy currents of rotatable object 12 without or with little attenuation, if possible. Receptacle 56 in particular may be configured in such a way that front end 60 of sensor section 24 is positioned as closely as possible to the passing compressor blades of compressor wheel 14. In addition, FIG. 5 illustrates that sensor section 24 may be mounted on compressor housing 50 such that longitudinal axis 40 is disposed at an angle α of 25° to 65°, which may be 30° to 60°, and even more which may be, 45°, such as precisely 45°, in relation to pivot axis 20.

Because of part 62 of the wall of compressor housing 50, the influencing of the magnetic field generated by eddy currents of rotatable object 12 decreases with increasing dimension d in the direction of longitudinal axis 40, which may also be referred to as thickness. Sensor device 10 may therefore include a signal amplifier, which is mounted on or included in circuit substrate 34. This amplifies the detected magnetic field and, for example, the voltage signal that goes hand-in-hand with this magnetic field. Without amplifier, it may happen, for instance, that only voltages in a range of a few mV could be picked off at magnetic-field sensor 28. Because of the amplifier, however, voltages of several volts, e.g., 5 V to 12 V, are able to be picked off for a precise analysis.

The acquisition of the rotation characteristic of rotatable object 12 in sensor device 10 may be based on the fact that magnetic-field generator 26 generates a magnetic field, especially a static magnetic field, at the location of rotatable object 12. In a turn, especially a rotation, of rotatable object 12, which in this instance is a compressor wheel 14, which turns, especially rotates, about pivot axle 20, eddy currents are produced which influence, especially change, the magnetic field and, in particular, the magnetic flux. The voltage able to be tapped off at magnetic-field sensor 28 is proportional to the temporal change of a magnetic flux at magnetic-field sensor 28.

Sensor device 10 according to the present invention enables a transmission of a signal from temperature sensor 30 separately from a signal of magnetic-field sensor 28, from an output of an evaluation circuit on circuit substrate 34, which may be embodied as circuit board, to an engine control unit, for instance. An additional pin, which conducts the signal to the engine control unit, may make this possible. The mass, i.e., the voltage potential, of the rotational speed sensor serves as common earth connection, i.e., as electrical connection for transmitting the voltage. As an alternative, a modulation of the signal of the temperature value acquired by temperature sensor 30 onto the signal of the rotational speed of compressor wheel 14, supplied by magnetic-field sensor 28, is possible. This may be realized with the aid of a pulse width modulation method or a multiplexing method. For example, an item of rotational speed information supplied by magnetic-field sensor 28 may be conducted in the form of a square-wave signal to an engine control unit (not shown), the period duration or frequency analysis being definable as needed. As mentioned, there is the additional possibility of transmitting the temperature information in a pulse-width modulated manner, for example, via the signals supplied by magnetic-field sensor 28 and integrated electronics. A corresponding temperature/pulse width correlation may be realized via software functions. As an alternative, depending on the configuration and complexity of the electronics integrated into sensor device 10, it is also possible to provide an intelligent interface, e.g., a single-edge nibble transmission (SENT) or a controller area network (CAN), by which the information is able to be transmitted. A transmission of the temperature signal by the pulse width modulation offers the advantage that the sensor device supplies a real-time signal of the rotational speed, so that run-time losses of the signal processing are able to be avoided.

Temperature sensor 30 thereby acquires the temperature of compressor housing 50 in a direct manner. Except for actual temperature sensor 30, no additional components are therefore required in exhaust-gas turbocharger 18. Furthermore, no additional wiring in the vehicle or at the engine for a temperature measurement is required either. As a result, for example, an intake temperature of the aspirated air downstream from compressor 16 is able to be ascertained indirectly. This temperature may be useful as additional control variable for correcting the air density in an engine control unit.

It is explicitly noted that all features disclosed in the description and/or in the claims are to be understood as separate and independent features for the purpose of the original disclosure and also for the purpose of restricting the claimed invention, independently of the feature combinations in the specific embodiments and/or the claims. It is explicitly stated that all indicated ranges or the specifications of groups of units disclose any possible intermediate value or subgroup of units for the purpose of the original disclosure and also for the purpose of restricting the claimed invention, especially also as limitation of an indicated range.

1-10. (canceled)

11. A sensor device for providing contactless acquisition of at least one rotation characteristic of a rotatable object, comprising:
at least one sensor housing;
at least one magnetic-field generator to generate a magnetic field at the location of the rotatable object;
at least one magnetic-field sensor to detect a magnetic field generated by eddy currents of the rotatable object; and
at least one temperature sensor;
wherein the magnetic-field generator and the magnetic-field sensor are at least partially and jointly disposed in a sensor section of the sensor housing, and
wherein the temperature sensor is at least partially disposed in the sensor section.

12. The sensor device of claim 11, further comprising:
an evaluation circuit, wherein a signal of the temperature sensor is transmittable, separately from or jointly with a signal of the magnetic-field sensor, from an output of the evaluation circuit.

13. The sensor device of claim 11, wherein the signal of the temperature sensor is transmittable together with the signal of the magnetic-field sensor from the output of the evaluation circuit and able to be modulated onto the signal of the magnetic-field sensor using a modulation technique.

14. The sensor device of claim 11, wherein the signal from the temperature sensor is modulatable onto the signal of the magnetic-field sensor with the aid of a pulse width modulation technique or a multiplexing technique.

15. The sensor device of claim 12, wherein the signal of the temperature sensor is transmittable from the output of the evaluation circuit separately from the signal of the magnetic-field sensor, and wherein the evaluation circuit has an additional connection port which is set up for transmitting the signal of the temperature sensor.

16. The sensor device of claim 12, wherein the signal from the temperature sensor is transmittable from the output of the evaluation circuit separately from the signal of the magnetic-field sensor, and wherein the evaluation circuit has an intelligent interface which is set up for transmitting the signal of the magnetic-field sensor.

17. The sensor device of claim 11, wherein the temperature sensor acquires a temperature of a wall of a device that includes the rotatable object.

18. The sensor device of claim 11, wherein the sensor section is configured so that in a state of the sensor housing in which it is mounted on a device that includes the rotatable object, a part of the device is situated between the sensor section and the rotatable object in a direction that is essentially parallel to a longitudinal axis of the sensor section.

19. The sensor device of claim 11, wherein the object is rotatable about a pivot axis, and wherein in a state of the sensor housing in which it is mounted on the device, the longitudinal axis of the sensor section is disposed at an angle of 25° to 65° in relation to the pivot axle.

20. The sensor device of claim 11, further comprising:
an amplifier to amplify a signal supplied by the magnetic-field sensor.

21. The sensor device of claim 11, wherein the object is rotatable about a pivot axis, and wherein in a state of the sensor housing in which it is mounted on the device, the longitudinal axis of the sensor section is disposed at an angle of 30° to 60° in relation to the pivot axle.

22. The sensor device of claim 11, wherein the object is rotatable about a pivot axis, and wherein in a state of the sensor housing in which it is mounted on the device, the longitudinal axis of the sensor section is disposed at an angle of 45° in relation to the pivot axle.

23. The sensor device of claim 11, wherein the sensor device is for providing contactless acquisition of the at least one rotation characteristic of the rotatable object, in particular for acquiring a rotational speed of a compressor wheel of a turbocharger.
